(19) United States
(12) Patent Application Publication
(10) Pub. No.: US 2005/0137502 A1
(43) Pub. Date: Jun. 23, 2005

(54) Massage apparatus

(75) Inventors: Toru Harashima, Osaka-shi (JP); Fumio Ooi, Osaka-shi (JP)

Correspondence Address: BIRCH STEWART KOLASCH & BIRCH, PO BOX 747, FALLS CHURCH, VA, 22040-0747, US

(73) Assignee: ATEX Co., LTD., Osaka-shi (JP)

(21) Appl. No.: 10/968,911

(22) Filed: Oct. 21, 2004

(30) Foreign Application Priority Data
Nov. 7, 2003 (JP) 2003-378767
Aug. 27, 2004 (JP) 2004-248806
Oct. 6, 2004 (JP) 2004-294095

(51) Int. Cl. A61H 7/00

(52) U.S. Cl. 601/84

(57) ABSTRACT

An object of the present invention is to provide a massage apparatus capable of improving a massage effect, and the massage apparatus comprises a massage means provided with massage bodies having pressing parts and provided in a rotation shaft rotated by means of a drive unit, the pressing parts pressing a user's massage parts via sheet bodies in conjunction with the rotation of the rotation shaft, and moving means housed in a box body for reciprocating the massage means in a moving direction orthogonal to a rotational central line of the rotation shaft, wherein the massage bodies are each composed of a cylindrical body provided in the rotation shaft to be thereby rotated, the cylindrical bodies pressing the massage parts by means of the pressing parts having a protruding shape and formed in outer peripheral surfaces thereof, or pressing boards disposed with intervals therebetween and having the pressing parts in surfaces thereof facing each other, and tilting means for periodically changing distances between the respective pressing parts facing each other by repeatedly tiling the pressing boards in reverse directions relative to each other in conjunction with the rotation of the rotation shaft and thereby sandwiching and massaging the massage parts.

### BACKGROUND OF THE INVENTION

1. Field of the Invention

The present invention relates to a massage apparatus for pressing and thereby massaging a user's massage parts with pressing parts which are rotated by means of a drive unit.

2. Description of the Related Art

In a conventional massage apparatus, as shown in FIG. 25, a drum d provided with a plurality of massage projections c in a peripheral part thereof is mounted on a rotation shaft b, which is driven by a motor a, in a relatively non-rotatable manner, in order to press the user's massage parts such as sole, calf, thigh, arm, lower back, or neck. In the massage apparatus, the massage projections c stimulate the massage parts in conjunction with the rotation of the drum d (as an example of which, refer to Japanese Unexamined Patent Publication No. H11-239596).

As another example, there is a massage apparatus, wherein a pair of right and left massaging members combined with a rotation shaft so as to tilt in reverse directions with respect to a central axis of the rotation shaft are provided, and massage parts sandwiched by the massaging members increasing and decreasing an interval therebetween in conjunction with the rotation of the rotation shaft is stimulated by pressure applied from the right and left directions (as an example of which, refer to Japanese Unexamined Patent Publication No. 2003-19174).

A problem included in such massage apparatuses which are designed to continuously stimulate the same massage part is that the user becomes unresponsive to the stimulation sooner or later. Therefore, the massage apparatuses could not obtain an effective massage effect. As an option to prevent such an inconvenience from happening, the user may change his/her posture to obtain the stimulation on a part he/she wishes to be massaged, which is, however, rather awkward in practical use.

### SUMMARY OF THE INVENTION

A main object of the present invention is, therefore, to provide a massage apparatus capable of solving the foregoing problems caused by the conventional massage apparatuses and improving the massage effect based on comprising moving means for reciprocating a massage means which presses the user's massage parts.

In order to achieve the foregoing object, an invention recited in claim 1 is characterized in comprising a massage means provided with massage bodies having pressing parts provided in a rotation shaft rotated by means of a drive unit, the pressing parts pressing user's massage parts via sheet bodies in conjunction with the rotation of the rotation shaft; and moving means housed in a box body for reciprocating the massage means in a moving direction orthogonal to a rotational central line of the rotation shaft.

An invention recited in claim 2 is characterized in that the massage bodies each comprise a cylindrical body provided in the rotation shaft to be thereby rotated, the cylindrical bodies pressing the massage parts by means of the pressing parts having a protruding shape and formed in outer peripheral surfaces thereof, or pressing boards disposed with intervals therebetween and having the pressing parts in surfaces thereof facing each other, and tiling means for periodically changing distances between the facing pressing parts by repeatedly tilting the pressing boards in reverse directions in conjunction with the rotation of the rotation shaft and thereby sandwiching and massaging the massage parts.

An invention recited in claim 3 is characterized in that the pressing parts of the pressing boards have a protruding shape expanded in a direction where the pressing parts face each other. An invention recited in claim 4 is characterized in that the pressing parts of the pressing boards have a smooth and annular surface.

An invention recited in claim 5 is characterized in that the tilting means are tilting receiving pieces supported in a non-rotatable manner relative to the rotation shaft and having tilting bearings tilted to thereby rotatably support the pressing boards. An invention recited in claim 6 is characterized in that a stroke of the reciprocation is 80 to 180 mm, and the number of reciprocations is 20 to 90 times/min.

An invention recited in claim 7 is characterized in that the massage means comprises the drive unit, the rotation shaft, the massage bodies, and support frames composed of bearing tools disposed on both sides of the rotation shaft, the bearing tools oscillatably supporting the rotation shaft on both ends of the rotation shaft, and a joint member for combining the both-side bearing tools in a non-rotatable manner relative to each other, and the moving means include guiding tools for supporting the bearing tools and slidably guiding the bearing tools in the moving direction.

An invention recited in claim 8 is characterized in that the moving means each comprise the guiding tool, a crank arm whose one end is fixed to the rotation shaft, and a vertical guide fitting having a vertical guiding part where a guiding body provided on another end of the crank arm can move and fixed to the box body. An invention recited in claim 9 is characterized in that the moving means each includes the guiding tool, the crank arm whose one end is fixed to the rotation shaft, and a lever whose one end is oscillatably supported by the box body, and another end of the crank arm and another end of the lever are rotatably engaged with each other. An invention recited in claim 10 is characterized in that the box body includes a pedestal and a leg part provided in a standing manner in the pedestal, the leg part fixing the vertical guide fitting.

An invention recited in claim 11 is characterized in that the drive unit is fixed to the joint member. An invention recited in claim 12 is characterized in that the drive unit is movably guided in the moving direction by a retaining body provided in the standing manner in the box body, and the moving means are reciprocating means for reciprocating the bearing tools in the moving direction.

The massage apparatus according to the present invention comprises the moving means for reciprocating the massage means for pressing the massage parts, therefore, the different massage parts can be stimulated in rotation by the pressing parts of the massage bodies. As a result, a remarkable massage effect can be continuously obtained in the extended massage parts.

When the massage bodies are constituted as in the invention according to claim 2, the massage parts can be effectively pressed and stimulated. When the pressing parts of the pressing boards are projected as in the invention according to claim 3, the massage parts can be more effectively stimulated. When the pressing parts of the pressing boards have the smooth and annular surface as in the invention according to claim 4, a smooth operation can be achieved preventing the pressing parts from being hooked.

When the pressing boards are rotatably supported by the tilting bearings as in the invention according to claim 5, a structure can be simplified while achieving the smooth tilting operation of the pressing boards. When the massage means is reciprocated in accordance with the stroke as in the invention according to claim 6, an outstanding massage effect can be obtained preventing the user from becoming insensitive to the pressing and stimulation.

When the guiding tools of the moving means slidably support and guide the bearing tools as in the invention according to claim 7, the massage means can be smoothly reciprocated. When the moving means is each composed of the guiding tool, crank arm, vertical guide fitting as in the invention according to claim 8, the massage means can be reciprocated by means of a rotational force of the rotation shaft. Further, when the moving means is each composed of the guiding tool, crank arm, lever as in the invention according to claim 9, the reciprocation of the massage means can exert a smooth and noiseless movement, and the stroke of the reciprocation can be set to a larger value.

In the invention according to claim 10, the vertical guide fittings can be stably supported and the box body can be formed in a compact size. When the drive unit is fixed to the joint member as in the, invention according to claim 11, the drive unit can be stably supported. When the drive unit is movably guided by the retaining body provided in the standing manner in the box body as in the invention according to claim 12, the massage means can be smoothly reciprocated.

### BRIEF DESCRIPTION OF THE DRAWINGS

FIG. 1 is a perspective view according to an embodiment of the present invention;

FIG. 2 is a frontal view of an internal structure according to the embodiment;

FIG. 3 is a plane view of the internal structure;

FIG. 4 is a A-A cross sectional view of FIG. 2;

FIGS. 5(A) to (C) are enlarged views of a main part for describing an operation of a massage means;

FIG. 6 is a schematic view of a main part for describing the massage means and a moving means;

FIGS. 7(A) to (C) are schematic views of a main part for describing an operation of the moving means;

FIG. 8 is a perspective view of a vertical guide fitting;

FIG. 9 is a front view of an internal structure according to another embodiment of the present invention;

FIG. 10 is a plane view of the internal structure;

FIGS. 11(A)-(C) are schematic views for describing an operation of a drive unit;

FIG. 12 is a front view of an internal structure according to still another embodiment of the present invention;

FIG. 13 is a side view of the internal structure;

FIG. 14 is an enlarged view of a main part of the internal structure;

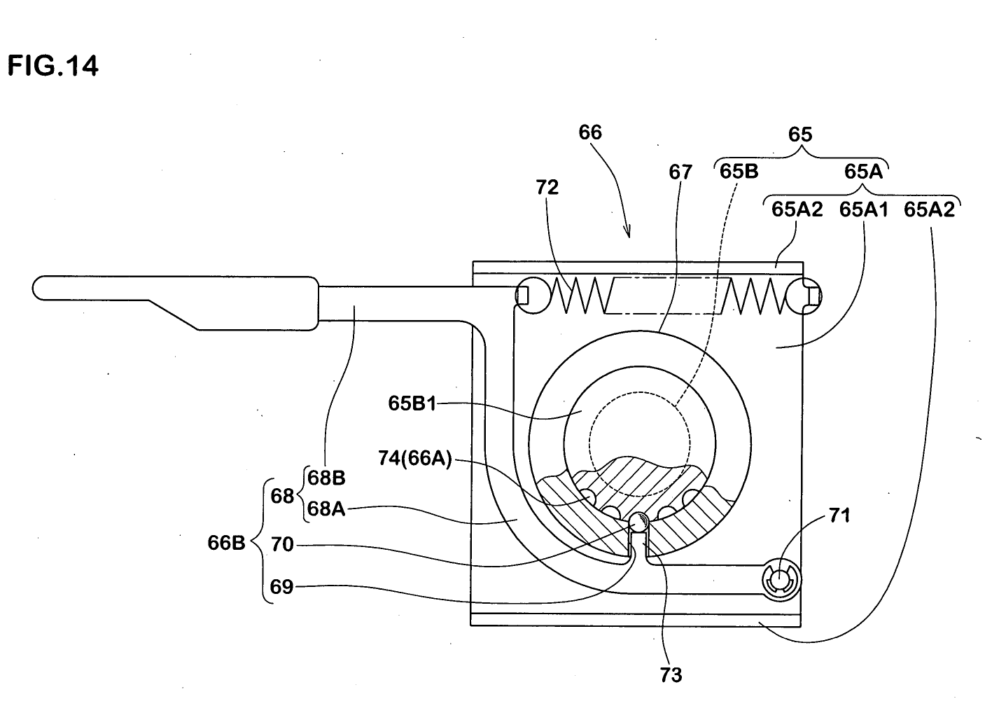

FIG. 15 is a cross sectional view of the main part;

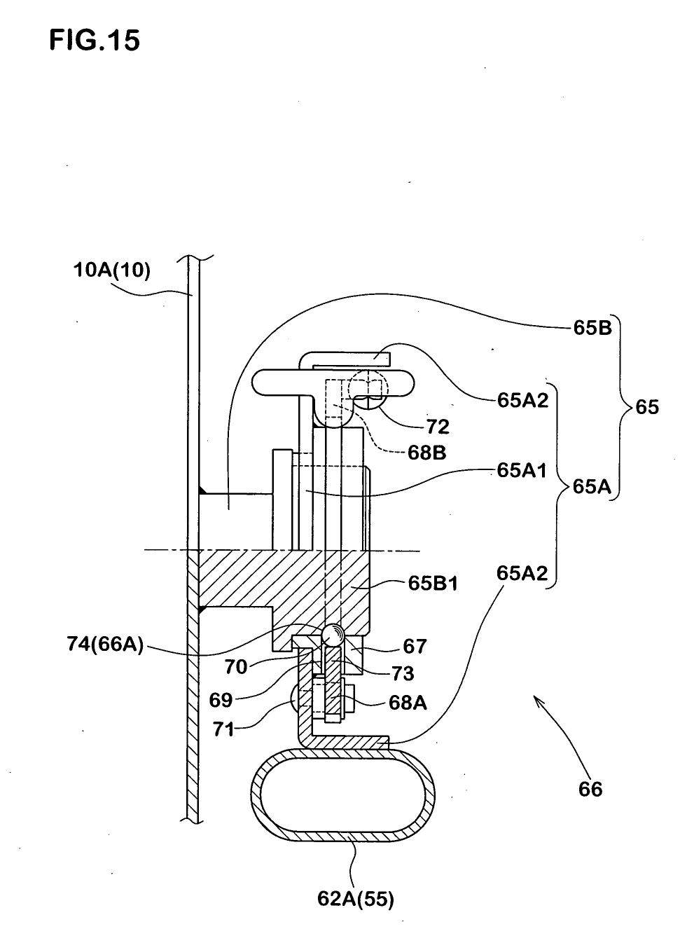

FIG. 16 is, a perspective view according to still another embodiment of the present invention;

FIG. 17 is a front view of an internal structure according to the embodiment;

FIG. 18 is a perspective view of an enlarged main part of the internal structure;

FIG. 19 is a perspective view of pressing boards according to still another embodiment;

FIG. 20 is a perspective view of a main part according to still another embodiment of the present invention;

FIG. 21 is a perspective view of a moving means of the main part;

FIGS. 22(A) to (D) are schematic views for describing an operation of the moving means;

FIG. 23 is a perspective view of a main part according to still another embodiment of the present invention;

FIGS. 24(A)-(D) are schematic views for describing an operation of a moving means; and

FIG. 25 is a schematic view according to a conventional technology.

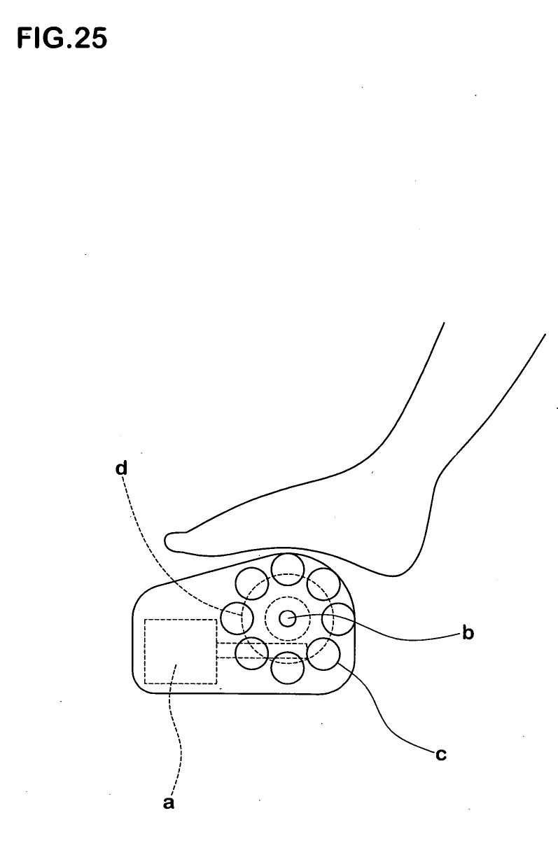

### DETAILED DESCRIPTION OF THE PREFERRED EMBODIMENTS

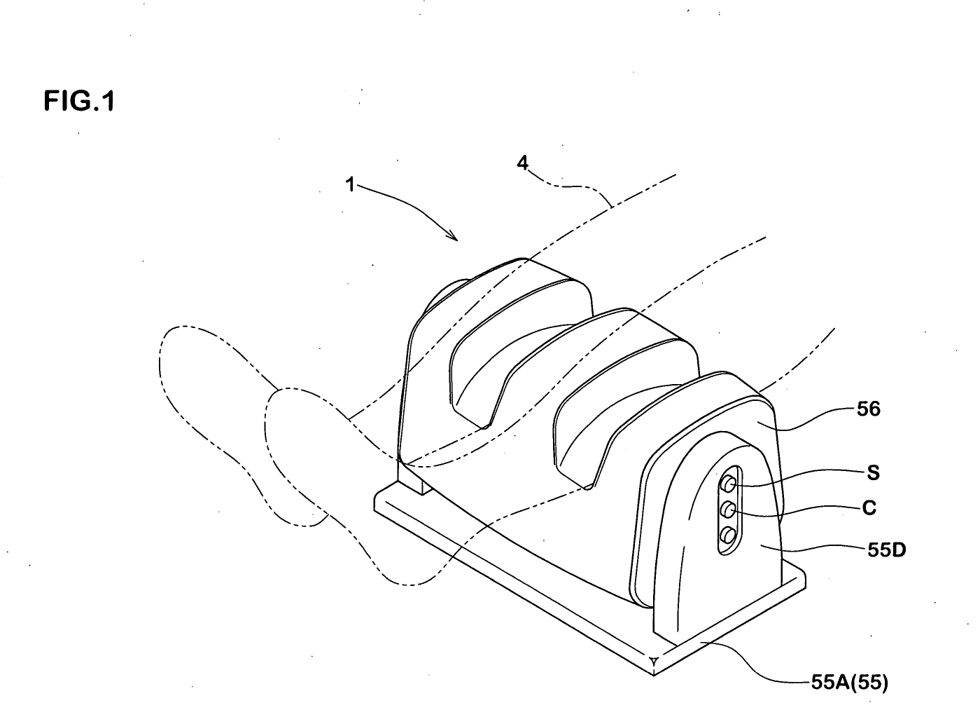

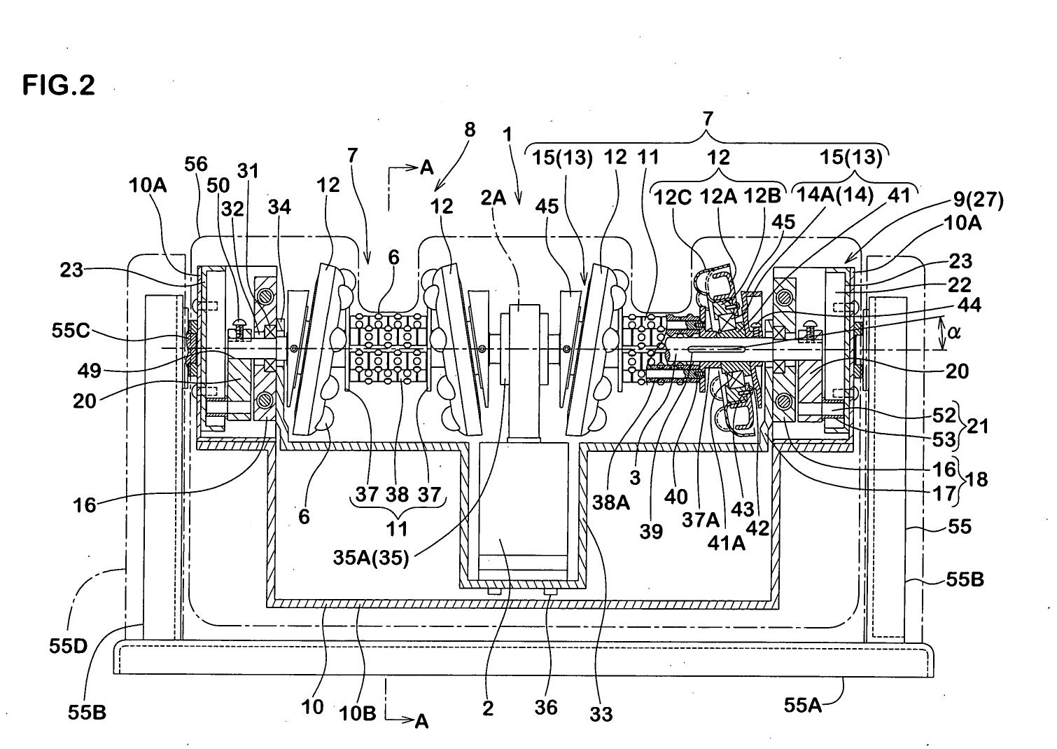

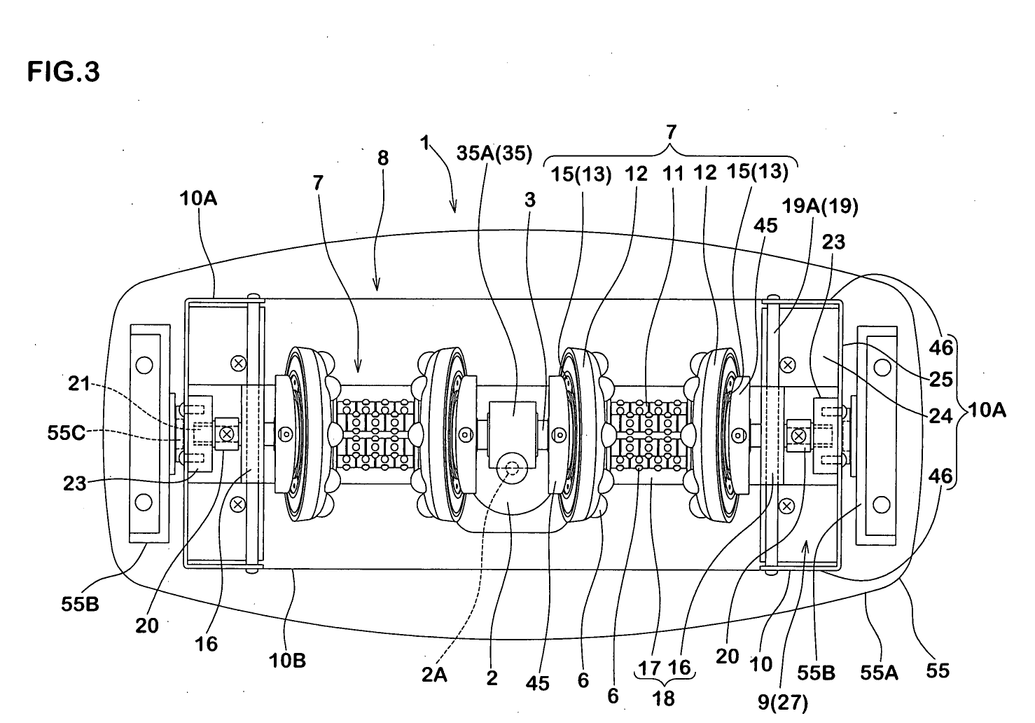

Hereinafter, an embodiment of the present invention is described referring to the drawings. FIG. 1 is a perspective view illustrating a state where a massage apparatus 1 is being used. FIG. 2 is a longitudinal sectional view of the massage apparatus 1. FIG. 3 is a plane view illustrating an internal structure of the massage apparatus 1. The massage apparatus 1 according to the present invention comprises a massage means 8 for pressing the user's massage parts and moving means 9 for reciprocating the massage means 8.

The present embodiment shows an example of the massage means 8, which comprises massage bodies 7, a rotation shaft 3 for supporting the massage bodies 7, a drive unit 2, and support frames 18. Further, the support frame 18 according to the present embodiment comprises bearing tools 16 and a joint member 17.

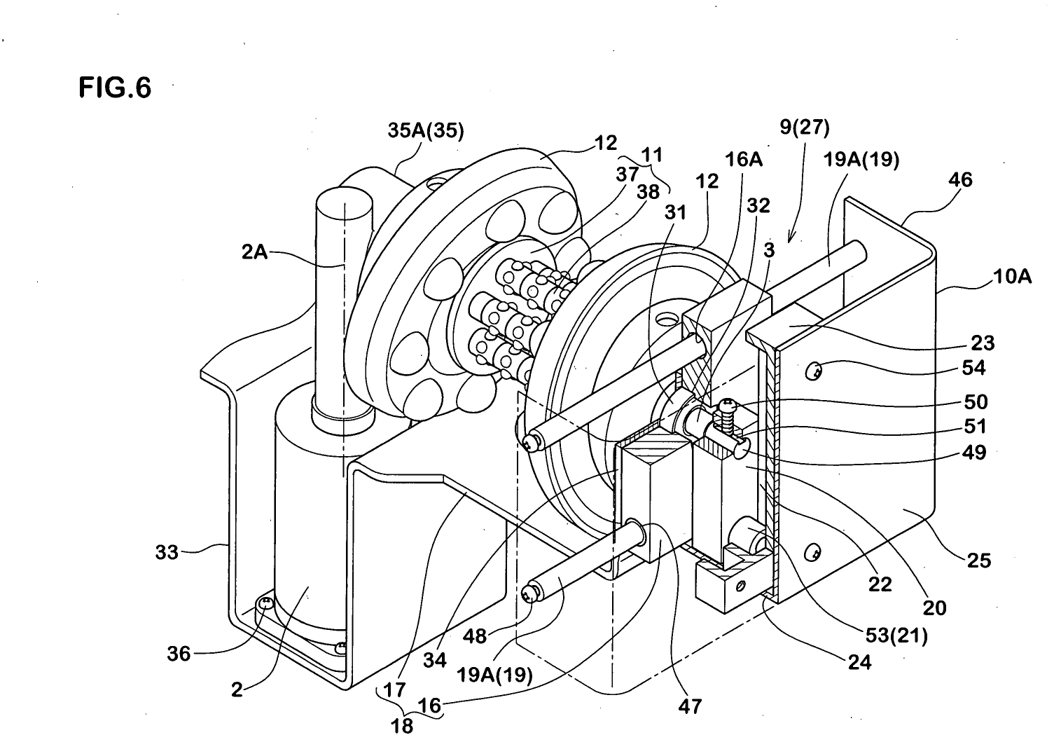

As shown in FIGS. 2 and 6, the bearing tools 16 according to the present embodiment have a shape of an upright rectangular thick plate and are provided with a support hole 32 comprising a bearing 31 in an approximate center thereof. A pair of the bearing tools 16 is disposed facing each other. The bearing tool 16 according to the present embodiment is formed from a steel stock having a horizontal width of, for example, approximately 60 to 90 mm, a vertical length of, for example, approximately 90 to 130 mm, and a thickness of, for example, approximately 15 to 22 mm.

The joint member 17 is provided so as to bridge the bearing tools 16 and has an indented part 33 protruded downward in a center thereof. The joint member 17 has a mounting piece 34 rising at both ends thereof and fixedly fitting the bearing tools 16 in surfaces thereof facing each other. The joint member 17 according to the present embodiment is formed from, for example, a bent steel stock of approximately 1.2 to 2.3 mm.

The rotation shaft 3 has a bar shape which horizontally extends and further has a circular shape in cross section. Both ends of the rotation shaft 3 are rotatably supported by the bearings 31 provided in the support holes 32 of the bearing tools 16. The rotation shaft 3 according to the present embodiment is formed from a round bar steel having a diameter of approximately 18 to 26 mm in the center thereof and a diameter of approximately 10 to 15 mm at both ends thereof. A length of the rotation shaft 3 in the present embodiment is, for example, approximately 460 mm.

In the present embodiment, the drive unit 2 is disposed in the indented part 33 of the joint member 17 and further fixedly fitted to the joint member 17 by means of fitting tools 36. As described, the drive unit 2 according to the present embodiment is preferable in that it is directly fixedly fitted to the joint member 17 to be stably supported. Further, the drive unit 2 applies a rotational force to the rotation shaft 3 by having a drive axis 2A thereof combined with an approximate center of the rotation shaft 3 via a deceleration unit 35. Thus, the drive unit 2 according to the present embodiment is constituted in such manner as movable in synchronization with the rotation shaft 3 via the bearing tools 16 and the joint member 17 while applying the rotational force to the rotation shaft 3.

The drive unit 2 according to the present embodiment is composed of an AC motor. Further, the drive unit 2 is connected to a 100V power supply for household use via an on/off switch S and a controller C including a motor rotation control circuit shown in FIG. 1, wherein a rotation of the motor is thereby controlled. The motor rotation control circuit controls the number of rotations of the motor and normal/reverse rotations of the motor, and is further capable of gradually increasing/decreasing the number of rotations by means of a microcomputer in accordance with waveforms programmed therein.

The deceleration unit 35 in the present embodiment is composed of a deceleration gear mechanism 35A having a worm gear whose deceleration ratio is, for example, approximately 1/20-100.

In the present embodiment, the massage bodies 7, which are mounted on the rotation shaft 3, each comprise a cylindrical body 11, pressing boards 12, and tilting means 13.

The cylindrical body 11 is composed of a pair of support boards 37 and a pressing rod 38 bridged over the support boards 37. The support boards 37 have a disk shape whose diameter is, for example, approximately 70 to 110 mm. The rotation shaft 3 is inserted into boss parts 37A provided in the center of the support boards 37. The support boards 37 are non-rotatably mounted on the rotation shaft 3 by means of a key, which is not shown, provided in a key groove 39 of the rotation shaft 3.

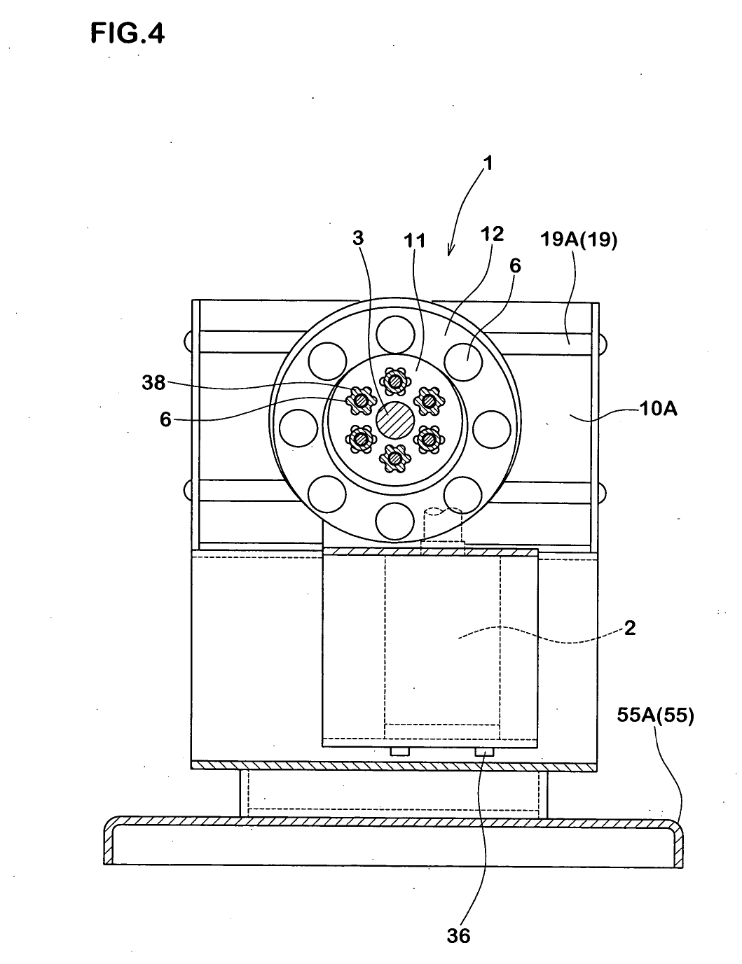

As shown in FIG. 4, the pressing rod 38 has a plurality of projected pressing parts 6 in an outer periphery thereof. The plurality of pressing parts 6 (six in the present embodiment) are equally spaced in an identical peripheral surface centered around the rotation shaft 3. Both ends of the pressing rod 38 are fixedly fitted to the support boards 37 by means of small screws. The pressing rod 38 according to the present embodiment is composed of a combined plurality of small cylinders 38A having projected pressing parts 6. The projected pressing parts 6 of the pressing rod 38 adjacent to one another are disposed in a houndstooth manner in order to disperse pressure applied to a massage part 4.

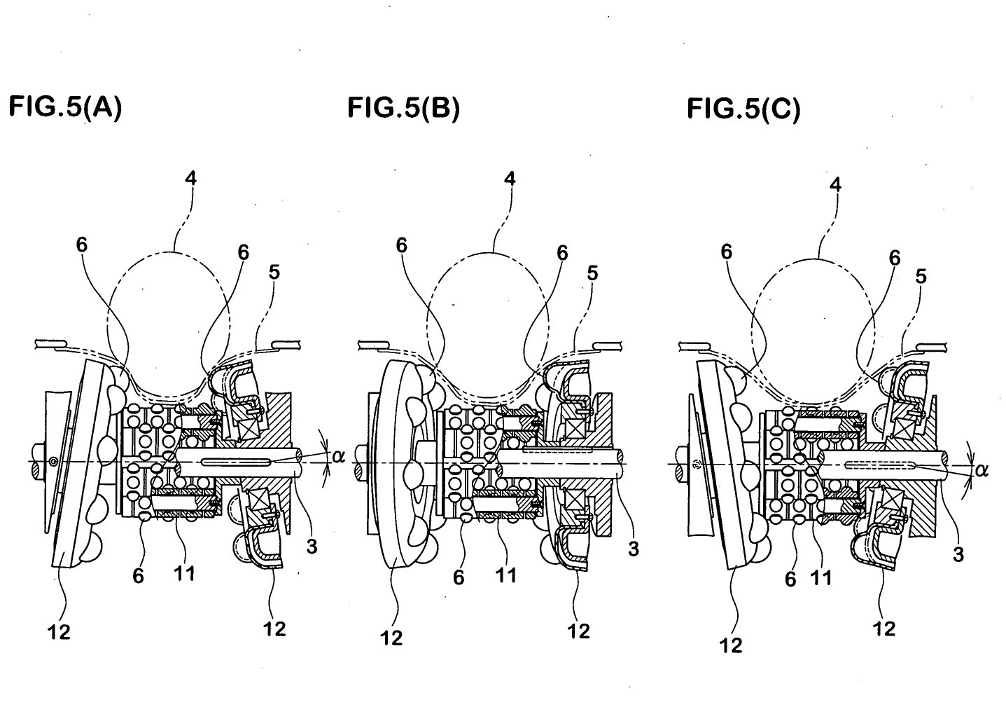

In the present embodiment, a pair of the cylindrical bodies 11 are disposed in the rotation shaft 3 with an interval of, for example, approximately 160 to 230 mm provided therebetween, as shown in FIG. 3. The projected pressing parts 6 of the cylindrical body 11, which rotates in conjunction with the rotation shaft 3, press and stimulate the user's massage part 4 such as sole, thigh, or arm, as shown in FIG. 5, thereby exerting a massage effect. Further, the rotational direction of the cylindrical bodies 11 may be changed in response to the control of the normal/reverse rotations of the drive unit 2 to thereby further enhance the massage effect. Sheet bodies 5 formed from felt, leather, or the like, are provided between the massage parts 4 and the cylindrical bodies 11 in order to ease the stimulation with respect to the massage parts 4.

As shown in FIG. 2, the pressing boards 12 in the present embodiment each have an approximate donut shape comprising an external board 12A, an internal board 12B, and a cover 12C, and are provided on both sides of the cylindrical body 11 so as to face each other. The external board 12A has an approximate ring shape and is fitted to an outer side of the internal board 12B. A flange 42 extending from an inner peripheral part toward an inner side of the external board 12A is fixedly fitted to the internal board 12B by means of a fitting tool 43, and the external board 12A and the internal board 12B are thereby formed as a unit. The cover 12C covers the surfaces of the external board 12A facing each other, and an inner peripheral part of the cover 12C is sandwiched by the external board 12A and the internal board 12B. Further, a plurality of projected pressing parts 6 expanded in a direction where they face each other is circumferentially spaced at intervals in a surface of the cover 12C. The present embodiment is thus preferable in that the pressing parts 6 of the pressing board 12 have a projection shape and can thereby apply a strong stimulation to the massage part. The cover 12C is formed from an elastic material such as styrene-butadiene rubber, chloroprene rubber, or other synthetic rubber, or olefin-based/styrene-based/urethane-based thermoplastic elastomer.

The pressing boards 12 according to the present embodiment are mounted on the rotation shaft 3 by means of tiling receiving pieces 15. The tiling receiving pieces 15 are composed of tiling hubs 41 mounted on the rotation shaft 3 on the both sides of the cylindrical body 11 and tilting bearings 14 provided in outer peripheral surfaces 41A of the tiling hubs 41.

The tiling hub 41 is formed in the manner that the outer peripheral surface 41A thereof is tilted at α degrees (for example, approximately 6 to 10 degrees) with respect to a central line X of the rotation shaft 3. A pair of the tilting hubs 41 sandwich the cylindrical body 11 and is non-rotatably mounted on the rotation shaft 3 by means of the key, which is not shown, provided in the key groove 39 in the state where the outer peripheral surfaces 41A thereof are tilted in reverse directions relative to each other.

The tiling bearings 14 of the present embodiment are formed from bearings 14A and mounted on the outer peripheral surfaces 41A of the tilting hubs 41. The internal boards 12B of the pressing boards 12 are rotatably supported by the bearings 14A. Therefore, a pair of the bearings 14A disposed so as to sandwich the cylindrical body 11 are tilted at α degrees in the reverse directions relative to each other with respect to the central line X of the rotation shaft 3. A pair of the pressing boards 12 mounted on the bearings 14A are tilted through α degrees in the reverse directions relative to each other with respect to the central line X of the rotation shaft 3 and rotatably supported. As a result, when the rotation shaft 3 is rotated, the facing pressing boards 12 are allowed to rotate relative to each other with respect to the rotation shaft 3 and are repeatedly tilted reverse to each other. A distance between the pressing parts 6 facing each other is thereby periodically increased and decreased. The pressing boards 12 constituted in the foregoing manner are preferable in that the smooth tiling can be achieved and the structure required for the tilting can be simplified.

Thus, as shown in FIG. 5(A), when the distance between the pressing parts 6 of the pressing boards 12 is decreased, the pressing parts 6 sandwich the massage part 4 therebetween via the sheet body 5 to thereby apply stimulate the massage part 4 by applying the pressure thereto. When the rotation shaft 3 is rotated through 90 degrees, as shown in FIG. 5(B), the pressing boards 12 are shifted to an upright position. Therefore, the distance between the pressing parts 6 is enlarged, thereby decreasing the pressure applied to the massage part 4. When the rotation shaft 3 is further rotated through 90 degrees, as shown in FIG. 5(C), the pressing boards 12 are tilted in the state where they open upward, thereby eliminating the pressure applied to the massage part 4. The foregoing operation is thereafter circulated, wherein, in addition to the massage effect obtained by the cylindrical body 11, the massage part 4 is sandwiched to be repeatedly subjected to the pressure and stimulation as a result of the periodical increase/decrease of the distance between the pressing parts 6 of the pressing boards 12 in conjunction with the rotation of the rotation shaft 3 so that the effective massage can be performed. Further, the massage effect can be further improved because the rotational direction of the drive unit 2 can be reversed to thereby invert the direction of the tilting operation.

The tilting receiving piece 15 according to the present embodiment constitutes the tilting means 13 for repeatedly tiling the pressing boards 12 in the reverse directions to thereby perform the massage. The cylindrical body 11 and the tilting means 13 supported by the rotation shaft 3 are sandwiched by a pair of fixing boards 45 fixedly fitted to the rotation shaft 3 by means of fitting tools 44 and thereby non-movably fixed in an axial direction of the rotation shaft 3. The massage body 7 may be formed from only the cylindrical body 11, or only the pressing boards 12 and the tilting means 13 without the cylindrical body 11.

The moving means 9 for reciprocating the massage means 8 comprises a guiding tool 19, a crank arm 20, and a vertical guide fitting 23, and is provided in a box body 10 in the present embodiment. The moving means 9 constitutes a reciprocating means 27 for reciprocating the bearing tools 16 in the moving direction.

The box body 10 of the present embodiment comprises side parts 10A disposed in the neighborhood of the both ends of the rotation shaft 3 and a combining part 10B for combining the side parts 10A. The side part 10A of the present embodiment comprises, as shown in FIG. 6, a pedestal 24, a leg part 25 provided to the pedestal 24 in the standing manner, and sleeve parts 46 formed from both sides of the leg part 25 bent inward by 90 degrees.

As shown in FIG. 6, the guiding tool 19 of the present embodiment is composed of a pair of slide shafts 19A having a shape of a horizontal round bar vertically bridged over the sleeve parts 46 of the box body 10. An end of the slide shaft 19A is fixedly fitted by means of a fitting tool 48 penetrated through the sleeve part 46. Further, the slide shafts 19A are respectively penetrated through slide holes 16A provided in the bearing tools 16 to thereby slidably support the bearing tools 16. The massage means 8 can be thereby smoothly reciprocated. The slide hole 16A has a bush 47 fitted thereto in order to increase the slidability with respect to the slide shaft 19A.

The both ends of the rotation shaft 3 supported by the support holes 32 of the bearing tools 16 are protruded from the support holes 32, and end parts of the crank arms 20 vertically extending with respect to the rotation shaft 3 are fixed to the protruding ends of the rotation shaft 3. The crank arm 20 is non-rotatably fixed to the rotation shaft 3 by fitting a mounting hole 49 formed in one end of the crank arm 20 to the end part of the rotation shaft 3, and further engaging a fitting tool 50 screwed into the one end of the crank arm 20 with a key groove 51 in the end part of the rotation shaft 3.

Further, the crank arm 20 has a guiding body 21 in another end of thereof. The guiding body 21 of the present embodiment comprises a support shaft 52 extending in parallel with the rotation shaft 3 and a roll 53 rotatably supported by the support shaft 52. The crank arm 20 is formed so that a length thereof extending from a pivoting point with respect to the rotation shaft 3 to the guiding body 21 is, for example, 40 to 90 mm, and 65 mm in the present embodiment.

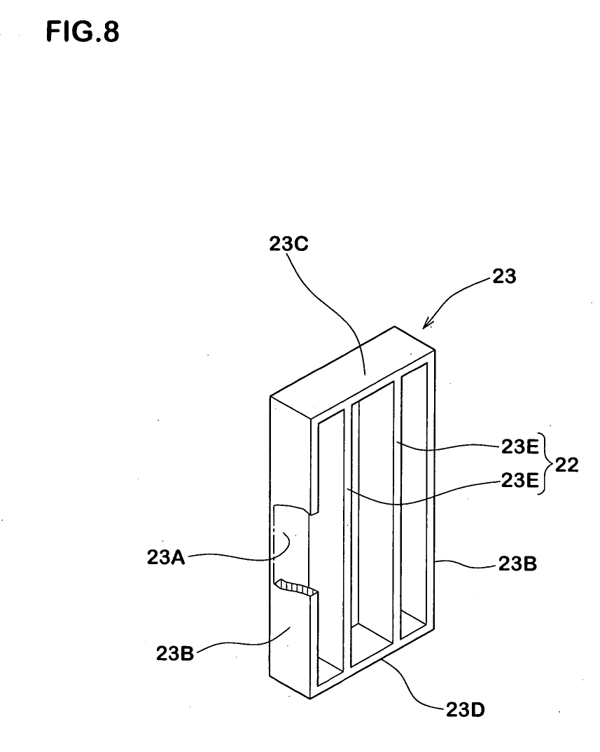

As shown in FIG. 8, the vertical guide fitting 23 according to the present embodiment comprises a substrate 23A having a shape of an upright rectangular plate, side pieces 23B formed from both ends of the substrate 23A bent by 90 degrees in the same direction, an upper piece 23C and a lower piece 23D formed from upper and lower ends of the substrate 23A bent by 90 degrees and serving to connect upper and lower ends of the side pieces 23B, and a pair of guide pieces 23E vertically extending between the upper piece 23C and the lower piece 23D inward of the side pieces 23B. The vertical guide fitting 23 is fixedly fitted to the leg part 25 of the box body 10 by means of a fitting tool 54 screwed into the substrate 23A between the side piece 23B and the guide piece 23E. The vertical guide fitting 23 according to the present embodiment is preferable in that it is directly stably fitted to the box body 10 and does not require any additional fitting tool to be interposed because of the direct fitting to the box body 10, thereby being reduced in size. The pair of guide pieces 23E movably guides the roll 53 fitted with a play therebetween in the vertical direction to thereby constitute the guiding part 22.

The vertical guide fittings 23 are respectively mounted on the both side parts 10A of the box body 10 and engaged with the crank arms 20 pivoted on the both ends of the rotation shaft 3. The crank arms 20 on the both sides are fixed to the rotation shaft 3 so that they are tilted at the same degrees in conjunction with the rotation of the rotation shaft 3.

Thus, the crank arm 20 is rotated by the rotation of the rotation shaft 3 around the rotation shaft 3. At that time, the roll 53 at an edge of the crank arm 20 is guided by the guiding part 22 of the vertical guide fitting 23 to thereby vertically slide between the guide pieces 23E. The roll 53, however, two-dimensionally (horizontally) maintains an identical position because the vertical guide fitting 23 is fixed to the leg part 25 of the box body 10. As a result, the rotation shaft 3 movably supported by the slide shaft 19A relatively moves in the horizontal direction and in the direction orthogonal to the rotational central line.

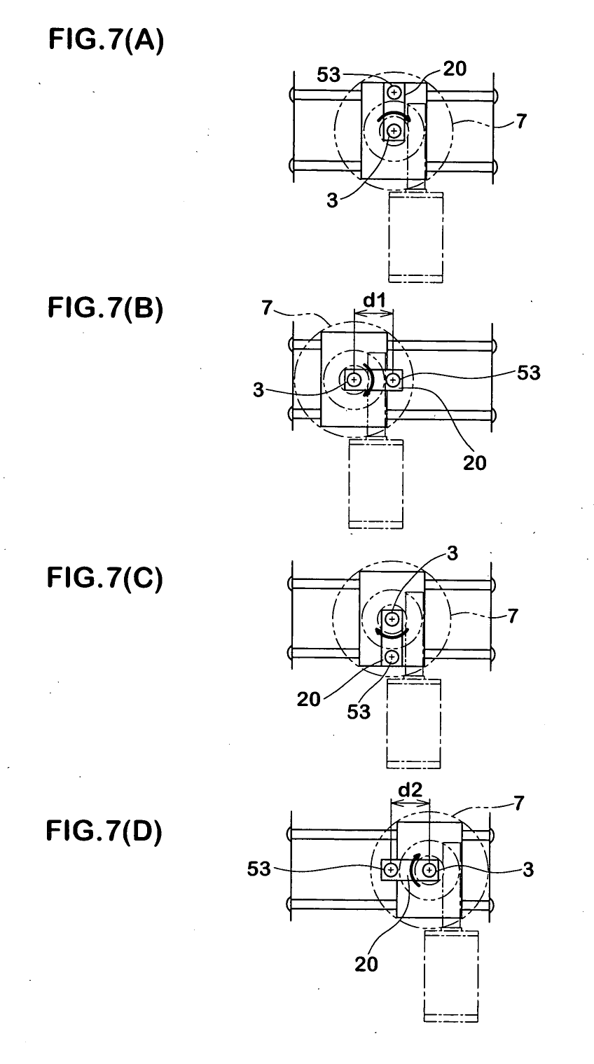

More specifically, as shown FIG. 7(A), when the crank arm 20 is in an upright position upward from the rotation shaft 3, the rotation shaft 3 is in a center position because the rotation shaft and the roll 53 are vertically lined up. When the rotation shaft 3 is rotated in a right direction on the drawing, the crank arm 20 is gradually tilted to the right, and the roll 53 slides downward in the guiding part 22. Therefore, the rotation shaft 3 relatively supported by the slide shaft 19A moves in a left direction on the drawing. When the rotation shaft 3 is rotated through 90 degrees, as shown in FIG. 7(B), the crank arm 20 is rotated to the right until it is disposed in the horizontal direction. The rotation shaft 3, therefore, relatively moves by d1 to the left from the center position. When the rotation shaft 3 is rotated through 180 degrees, as shown in FIG. 7(C), the crank arm 20 moves to a position downward from the rotation shaft 3. At that time, the rotation shaft 3 returns to the center position since the rotation shaft 3 and the roll 53 are vertically lined up. Further, when the rotation shaft 3 is rotated through 270 degrees, as shown in FIG. 7(D), the crank arm 20 is rotated to the left until it is in disposed in the horizontal position on the drawing. The rotation shaft 3, therefore, relatively moves by d2 to the right from the center position. When the rotation shaft 3 is rotated through 360 degrees, the rotation shaft 3 returns to the initial position shown in FIG. (A).

Thus, the rotation shaft 3 supported by the moving means 9 including the guiding tools 19, crank arms 20, vertical guide fittings 23 repeatedly reciprocates in the direction orthogonal to the rotational central line by means of its own rotational force applied by the drive unit 2. Therefore, the massage body 7 provided in the rotation shaft 3 repeatedly reciprocates in the direction orthogonal to the rotational central line while massaging the user's massage part 4 using the pressing parts 6 to thereby press and stimulate the massage part 4 at different positions in turn. As a result, the user can enjoy the effective massage result obtained in a plurality of massage parts without changing his/her posture.

The crank arm 20 is formed so that the length thereof extending from the pivoting point with respect to the rotation shaft 3 to the guiding body 21 is, as described, 40 to 90 mm (65 mm in the present embodiment), the stroke of the reciprocation is arranged to be 80 to 180 mm, preferably 100 to 160 mm, and 130 mm in the present embodiment. When the stroke is less than 80 mm, the massage is given in too a small range. Therefore, the massage effect is reduced because the user feels unsatisfied getting used to the pressing and stimulation too soon. When the stroke exceeds 180 mm, it is rather awkward to use the massage apparatus because the massage is given beyond a range to be massaged in sole, thigh, arm, or the like.

The number of reciprocations of the massage body 7, which is controlled by the rotation number control implemented by the drive unit 2 and the deceleration ratio of the deceleration unit 35, is desirably set to 20 to 90 times/min, and more desirably to 30 to 65 time/min. In the present embodiment, the number of reciprocations is set to three stages of 30, 45, and 60 times/min. When the number of reciprocations of the massage body 7 is less than 20 times/min, the moving speed of the massage body 7 is too slow, which results in a lowered massage effect because of the user's dissatisfaction for the pressing and stimulation. When the number of reciprocations of the massage body 7 exceeds 90 time/min, the massage body 7 moves too fast, which reduces the massage effect obtained from the pressing and stimulation applied by the pressing parts 6.

The box body 10 is supported by a stand 55. The stand 55 comprises a substrate 55A, and support walls 55B provided distant from the substrate 55A. The support walls 55B are disposed so as to face the side parts 10A of the box body 10 and oscillatably supports the side parts 10A by means of a pivoting means 55C. Further, the side walls 55B are covered with a dressing cap 55D, and the box body 10 is housed in a dressing case 56.

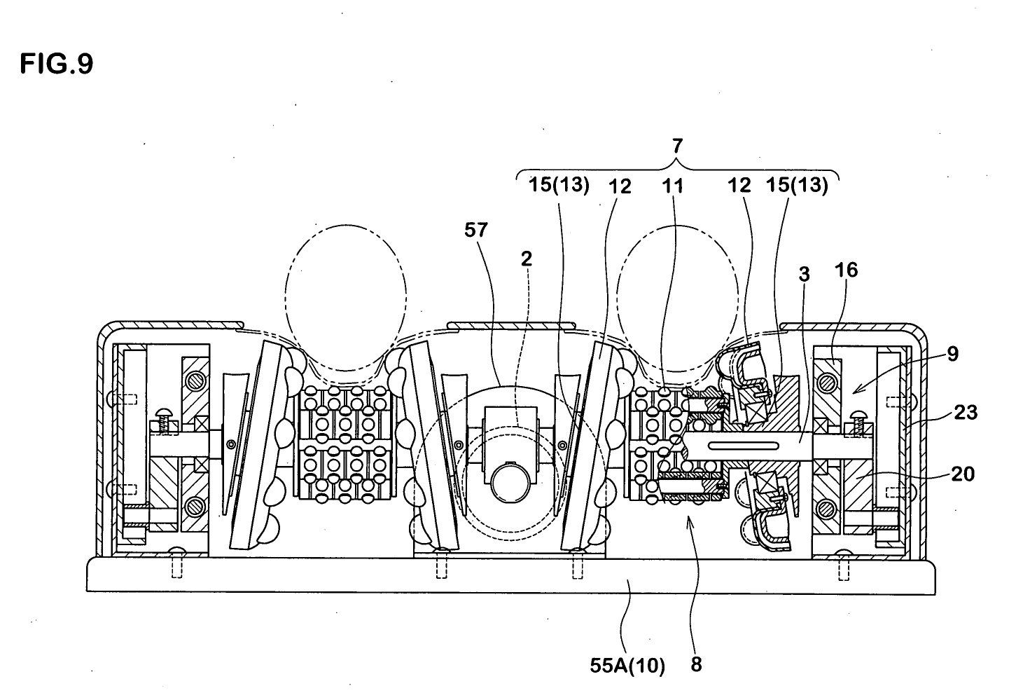

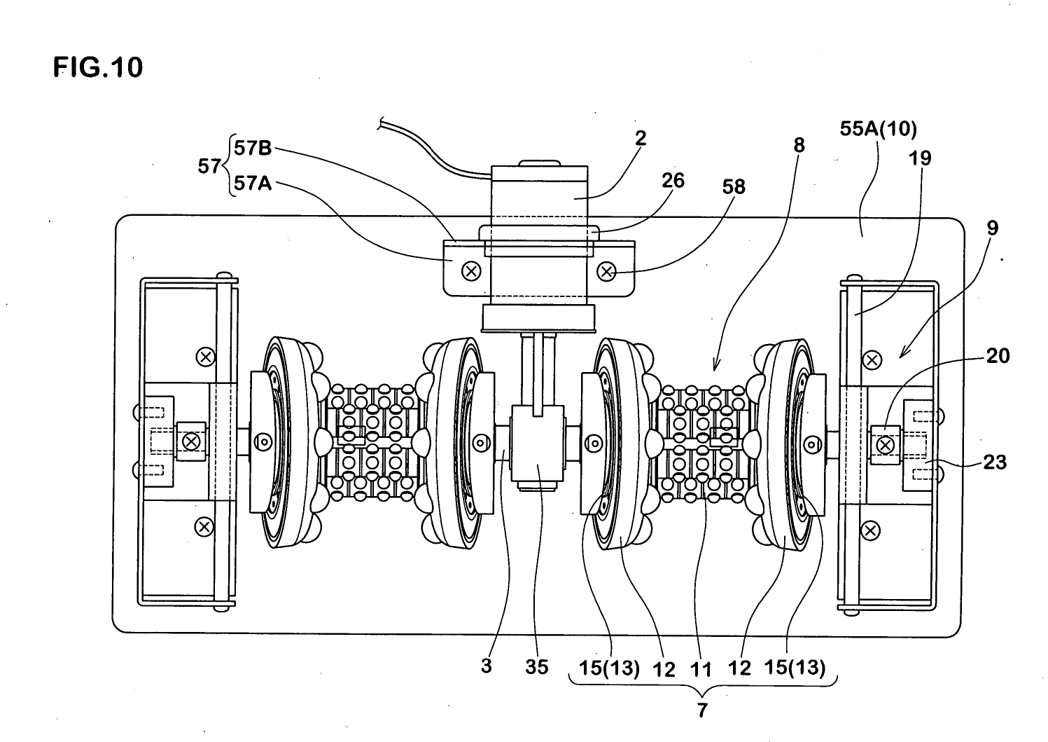

FIGS. 9 and 10 show another embodiment of the present embodiment. Any component, which is identical to those recited in the previous embodiment, is not described in the present embodiment and simply provided with the same reference symbols. A drive unit 2 according to the present embodiment is combined with the rotation shaft 3 via the deceleration unit 35 and thereby moves in conjunction with the movement in the moving direction orthogonal to the rotational central line of the rotation shaft 3. The drive unit 2 is slidably supported in the moving direction by a retaining body 26 having a short cylindrical shape and provided in the standing manner in the substrate 55A of the box body 10. The retaining body 26 comprises a bush (not shown) in an inner peripheral surface thereof and fixed to the substrate 55A by means of a fixing tool 57. The fixing tool 57 has an angle shape comprising a substrate 57A and a rising plate 57B bent upward from an end portion of the substrate 57A. The substrate 57A is fixedly fitted to the substrate 55A by means of a fitting tool 58, and fits the retaining body 26 to a mounting hole of the rising plate 57B. Thus, the drive unit 2 according to the present embodiment is preferable in that the massage means 8 is smoothly reciprocated because the drive unit 2 is supported so as to move in the moving direction by the retaining body 26 provided in the standing manner in the box body 10.

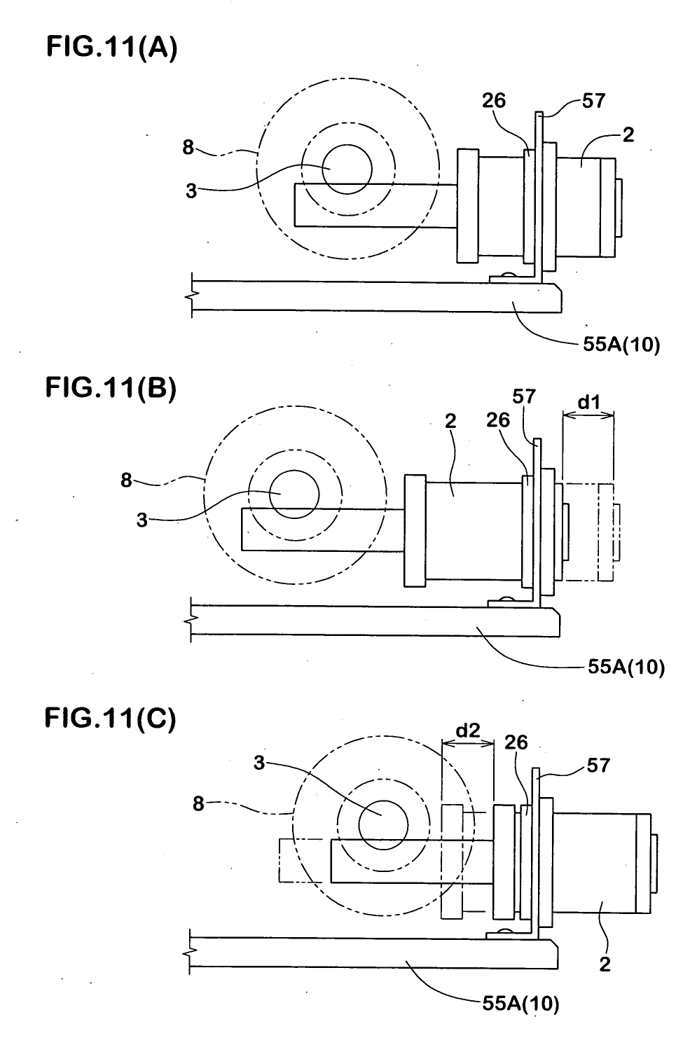

Thus, when the rotation shaft 3 is reciprocated in the moving direction together with the massage means 8 by means of the moving means 9, the drive unit 2 guided by the retaining body 26 moves in response to the movement of the rotation shaft 3. More specifically, when the rotation shaft 3 is in the center position as shown in FIG. 7(A), the drive unit 2 is likewise in the center position as shown in FIG. 11(A). When the crank arm 20 is rotated through 90 degrees to the right until it is disposed in the horizontal position and the rotation shaft 3 thereby moves by d1 to the left from the center position as shown in FIG. 7(B), the drive unit 2, in conjunction with the movement, is guided by the retaining body 26 to thereby move by d1 to the left, as shown in FIG. 11(B). Next, when the rotation shaft 3 is rotated through 180 degrees and the rotation shaft 3 thereby returns to the center position as shown in FIG. 7(C), the drive unit 2 returns to the center position as shown in FIG. 11(A). When the crank arm 20 is rotated to the left until it is disposed in the horizontal position and the rotation shaft 3 thereby moves by d2 from the center position to the right as shown in FIG. 7(D), the drive unit 2 is guided by the retaining body 26 to thereby move by d2 to the right on the drawing, as shown in FIG. 11(C). When the rotation shaft 3 is rotated through 360 degrees, the drive unit 2 returns to the initial position shown in FIG. 11(A). The moving means 9 according to the present embodiment is identical to that of the previous embodiment, and therefore described referring to FIGS. 7(A) to (D).

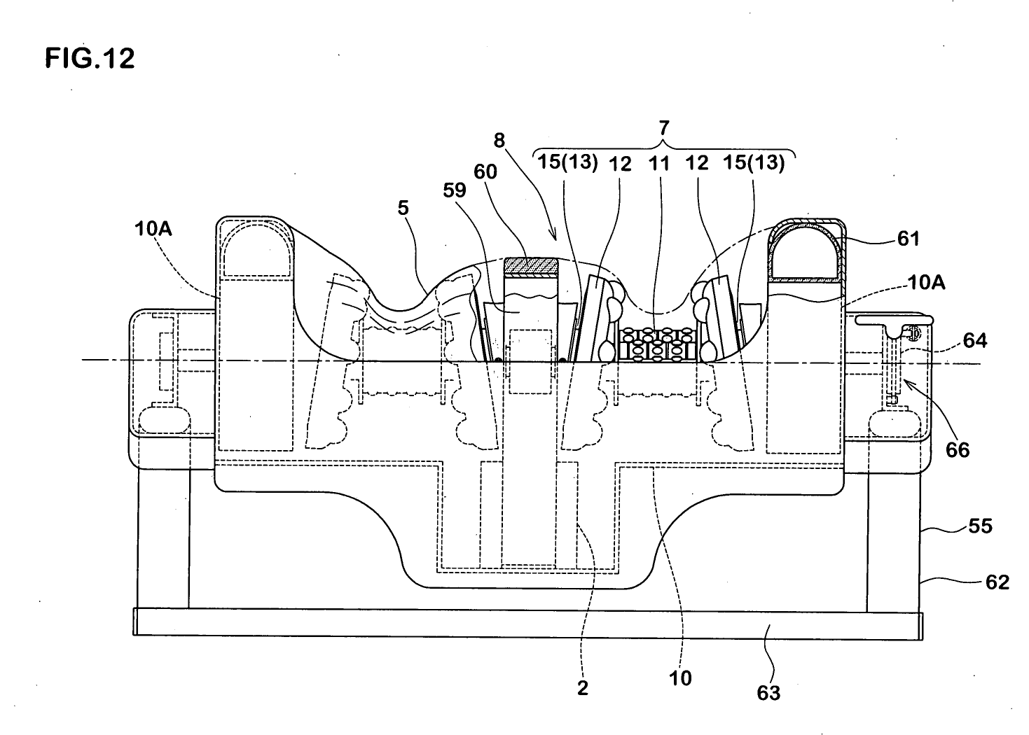

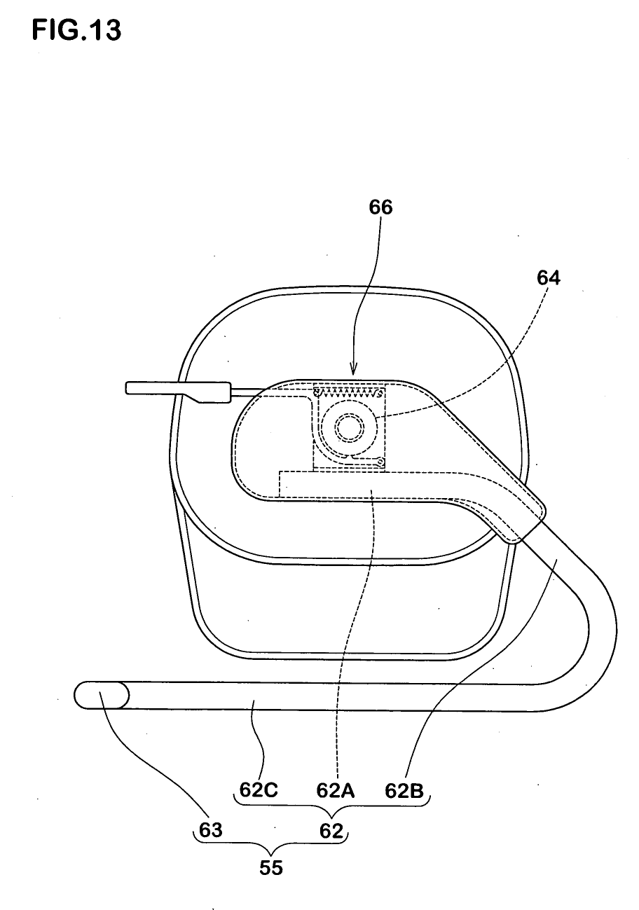

FIGS. 12 and 13 show still another embodiment of the present embodiment. A frame 59 having a reverse U-letter shape for covering the drive unit 2 is mounted on the box body 10 in a center thereof. An outer peripheral part of the frame 59 is coated with a cushion layer 60 in order to protect the user's massage part 4. The cushion layer 60 is formed from sponge such as urethane form or polyethylene form, olefin-based or styrene-based thermoplastic elastomer, synthetic rubber such as styrene butadiene rubber or chloroprene rubber, or other material.

Resin caps 61 having a curved shape are mounted on the side parts 10A of the box body 10 in order to prevent edge parts of the side parts 10A from damaging the user's massage part 4. The resin cap 61 is formed from a plastic material such as polyethylene, polypropylen, or polystylene. The massage body 7 and the cushion layer 60 are covered with the sheet body 5 formed from felt, leather, or the like.

The stand 55 supporting the box body 10 according to the present embodiment comprises a bent leg 62 and a combining rod 63 as shown in FIG. 13. The bent leg 62 comprises a horizontal support rod 62A, a tilting rod 62B bent and tilted downward from one end of the support rod 62A, and a disposing rod 62C further bent in the same direction below the tilting rod 62B and extending in parallel with the support rod 62A, and has an approximate U-letter shape. The combining rod 63 connects end portions of the disposing rods 62C of the bent legs 62 disposed with an interval therebetween. Further, a support part 64 is formed in the support rods 62A of the stand 55. The support part 64 supports the side parts 10A of the box body 10. The stand 55 according to the present embodiment is preferable in that a pair of the bent legs 62 and the combining rod 63 are continuous to thereby form a frame shape, thereby achieving a reduced weight and stable support.

The present embodiment shows as an example of the support part 64, which comprises a pivoting means for oscillatably supporting the side part 10A and a fixing means 66 for fixing an angle of the pivoting. The pivoting means 65 comprises a support substrate 65A fixedly fitted to the support rod 62A and a pivoting shaft 65B formed in a protruding manner in the leg part 25 of the side part 10A.

The support substrate 65A comprises a substrate main body 65A1 having an upright rectangular shape, and flanges 65A2 formed from upper and lower ends of the substrate main body 65A1 bent by 90 degrees. The lower flange 65A2 is welded on the support rod 62A, and the support substrate 65A is thereby fixedly fitted to the support rod 62A. Further, a bush 67 capable of supporting the rotation shaft in a surface contact is fitted and fixed to the center of the support substrate 65A.

The pivoting shaft 65B has a guiding shaft part 65B1 formed so as to have a larger diameter in an edge thereof, and the guiding shaft part 65B1 is rotatably inserted into the bush 67. As a result, the box body 10 is supported so as to rotate around the pivoting shaft 65B.

The fixing means 66 comprises a to-be-engaged part 66A provided in the pivoting shaft 65B and an engaging means 66B engaged with the to-be-engaged part 66A and disabling the rotation of the pivoting shaft 65B. The to-be-engaged part 66A according to the present embodiment is formed from a plurality of indented parts 74 circumferentially provided with intervals therebetween in a peripheral surface of the guiding shaft part 65B1. The indented parts 74 are spaced at a pitch of approximately 15 to 30 degrees with respect to a central line of the pivoting shaft 65B, and at the pitch of 22.5 degrees in the present embodiment.

The engaging means 66B according to the embodiment comprises an operation lever 68, a through hole 69 formed in a lower part of the bush 67, and an engaging ball 70 movable in the through hole 69.

The operation lever 68 comprises a curved part 68A whose one end is oscillatably fitted to a lower part of the support substrate 65A by means of a pin 71 and formed along an outer periphery of the bush 67 and a grip part 68B bent outward from another end of the curved part 68A. A pull spring 72 for energizing the curved part 68A toward the bush 67 is mounted on the another end of the curved part 68A. An inner surface of the curved part 68A is provided with a protruding piece 73, whose edge is inserted into the through hole 69 to thereby press the engaging ball 70.

The indented parts 74 are formed in a size capable of fitting an approximate half of the engaging ball 70. Therefore, the engaging ball 70 pressed by the protruding piece 73 energized by the pull spring 72 is retained in a position between the through hole 69 of the bush 67 and the indented parts 74 of the pivoting shaft 65B. As a result, the engaging ball 70 prevents the rotation of the pivoting shaft 65B.

When the operation lever 68 is tilted against a spring force by the operation of the grip part 68B, the protruding piece 73 is, in conjunction with the tilting, retreats in the through hole 69. Therefore, the engaging ball 70 escapes from the indented parts 74 by its own weight, thereby releasing the engagement between the pivoting shaft 65B and the bush 67. In the foregoing state, the user can adjust and select the tilt of the massage means 8 provided in the box body 10. When the grip part 68B is returned to the original position in compliance with the spring force after the adjustment, the engaging ball 70 is caught again in the indented parts 74. As a result, a most suitable tilting subjected to the adjustment and selection can be maintained, which improves the massage effect.

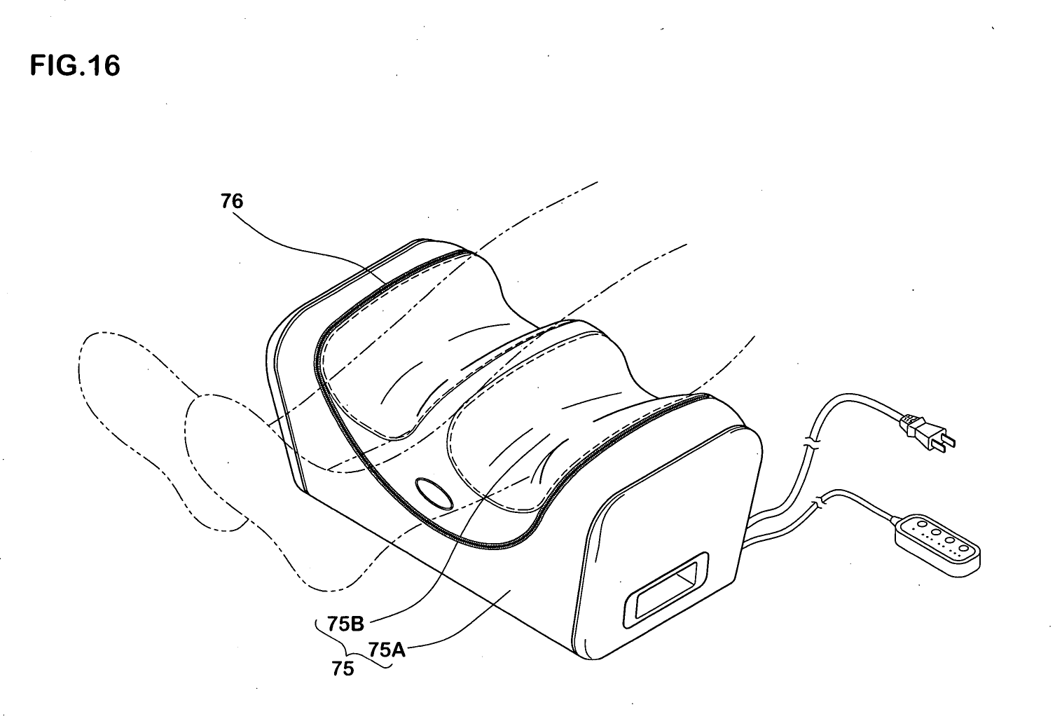

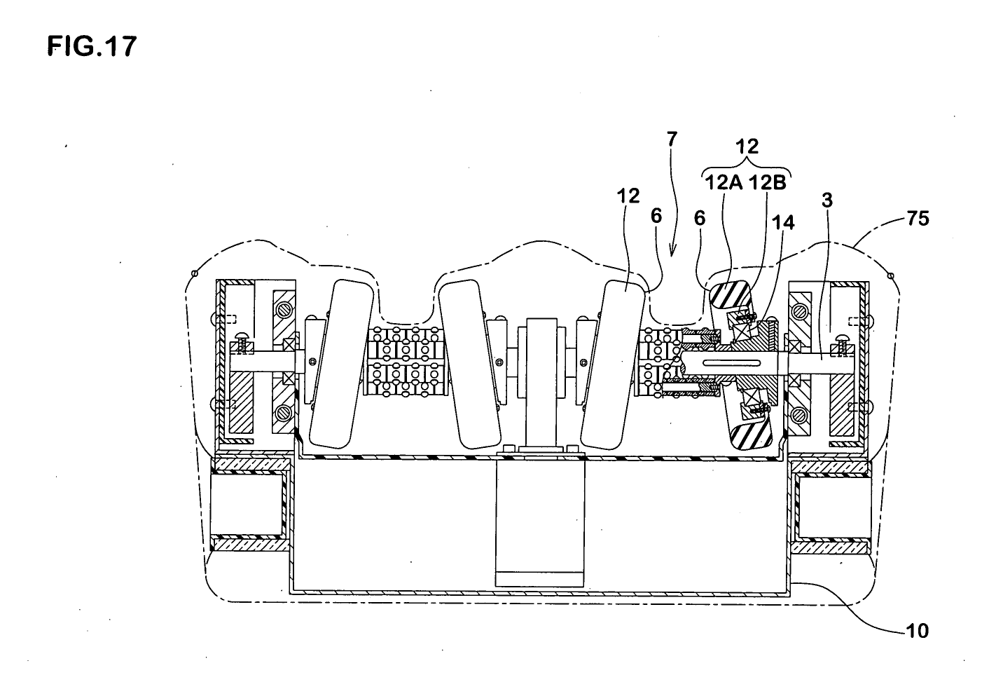

FIGS. 16 and 17 show still another embodiment of the present invention. A box body according to the present embodiment is entirely covered with a dressing cover 75. The dressing cover 75 comprises a cover base part 75A covering a lower part of the box body 10 and an upper cover 75B covering an upper part of the massage body 7. The upper cover 75B is mounted on the cover base part 75A by means of a fastener 76 so as to open and close. Further, the upper cover 75B is made from a thin and flexible fabric, a resin sheet, or the like so that the movement and pressure of the massage body 7 can be directly conveyed to the massage part. In the present embodiment, the box body 10 is used being directly disposed on a floor surface instead of being supported by the stand, as shown in FIG. 16. In the foregoing manner, the massage can be given in a stable state, and an entire body of the apparatus can be constituted in a compact size.

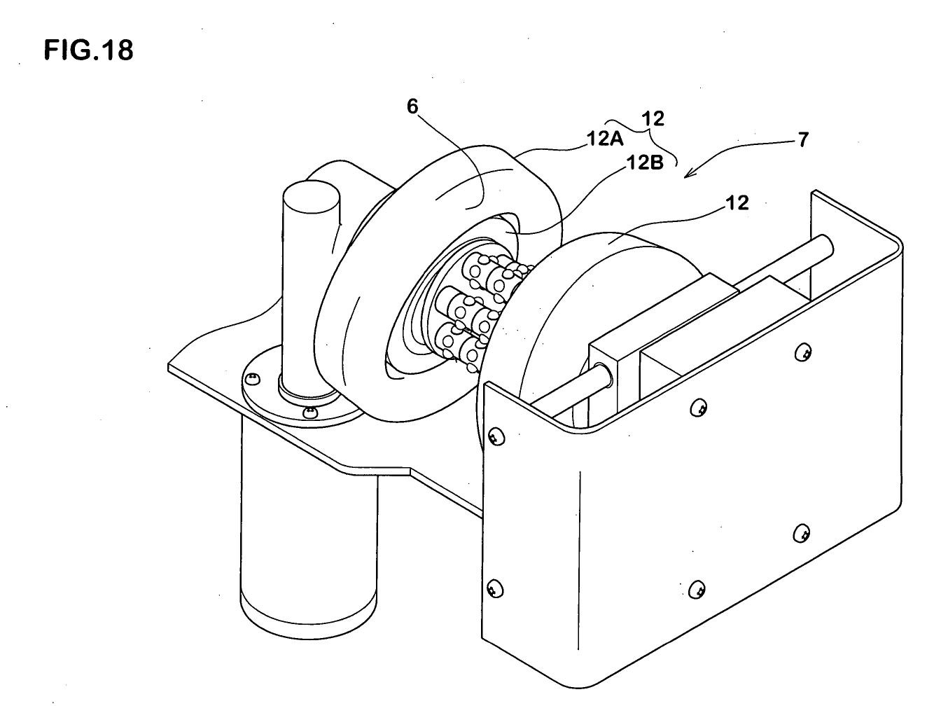

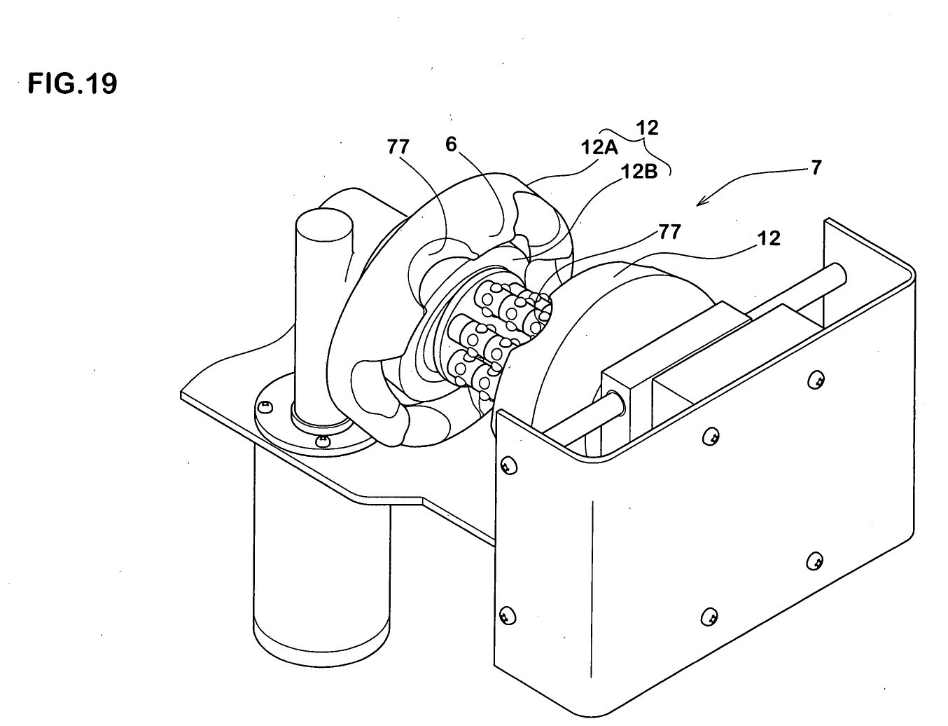

As shown in FIGS. 17 and 18, in the present embodiment, a pair of pressing boards 12 supported as tilted in the reverse directions relative to each other with respect to the rotation shaft 3 by means of the tiling bearings 14 each comprise an internal board 12B rotatably fitted to the tiling bearing 14 and an external board 12A having a ring shape and fitted to an outer side of the internal board 12B. On surfaces of the external boards 12A facing each other are formed pressing parts 6 having a smooth and annular surface. The pressing parts 6 according to the present embodiment are smooth having no uneven part. Therefore, when the pressing parts 6 are rotated, a friction generated with respect to the dressing cover 75 can be reduced, and the pressing parts 6 can be prevented from being hooked on the massage part, thus achieving a smooth operation. The external board 12A is formed from an elastic material exemplified by styrene-butadiene rubber, chloroprene rubber, other synthetic rubber olefin-based/styrene-based/urethane-based thermoplastic elastomer, or the like. Further, as shown in FIG. 19, indentations 77 can be circumferentially formed with intervals therebetween in the pressing parts 6 of the pressing boards 12, which is preferable in that the massage effect can be enhanced because the indentations 77 generate a variation in pressing the massage part.

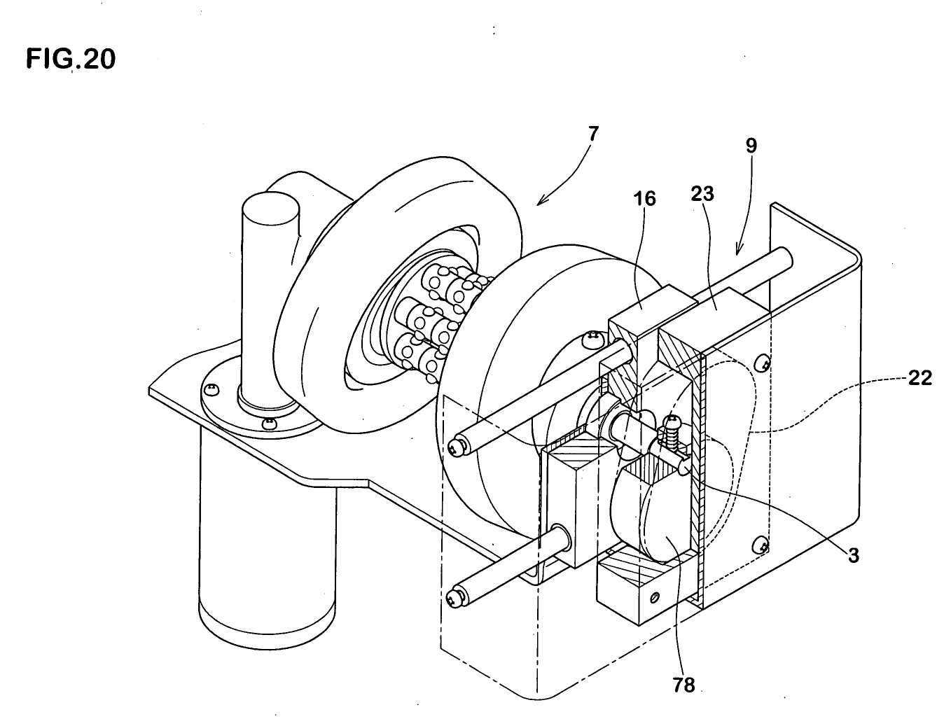

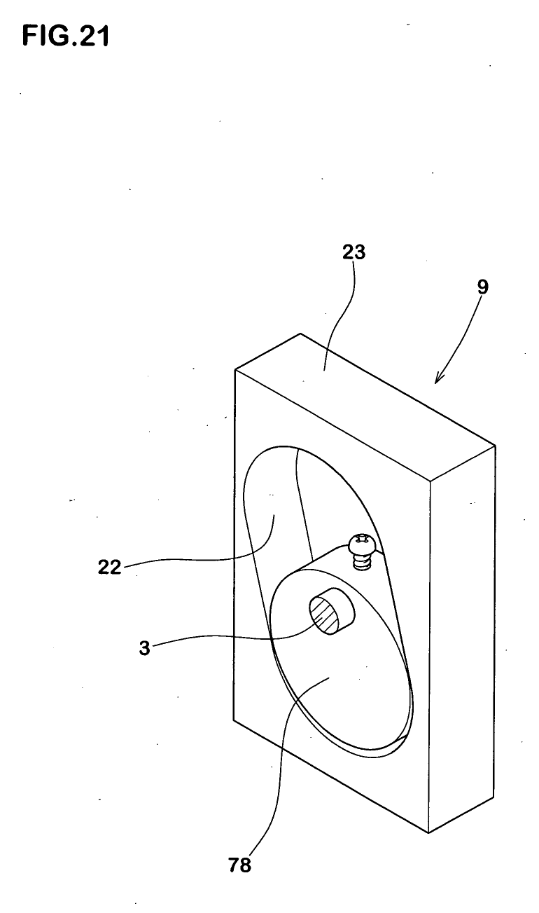

FIG. 20 shows still another embodiment of the present invention. As shown in FIG. 21, moving means 9 according to the present embodiment each comprise a vertical guide fitting 23 and a circular eccentric cam 78. A guiding part 22 having a shape of a vertically longer indentation whose vertical central line is tilted with respect to perpendicularity in the vertical guide fitting 23. The circular eccentric cam 78 is fixedly fitted to the end part of the rotation shaft 3 and inserted into the guiding part 22. The circular eccentric cam 78 rotating integrally with the rotation shaft 3 slides in contact with an inner peripheral surface of the tilted guiding part 22 to be thereby guided. As a result, the rotation shaft 3 supported by the bearing tools 16 is reciprocated in the direction orthogonal to the central line thereof.

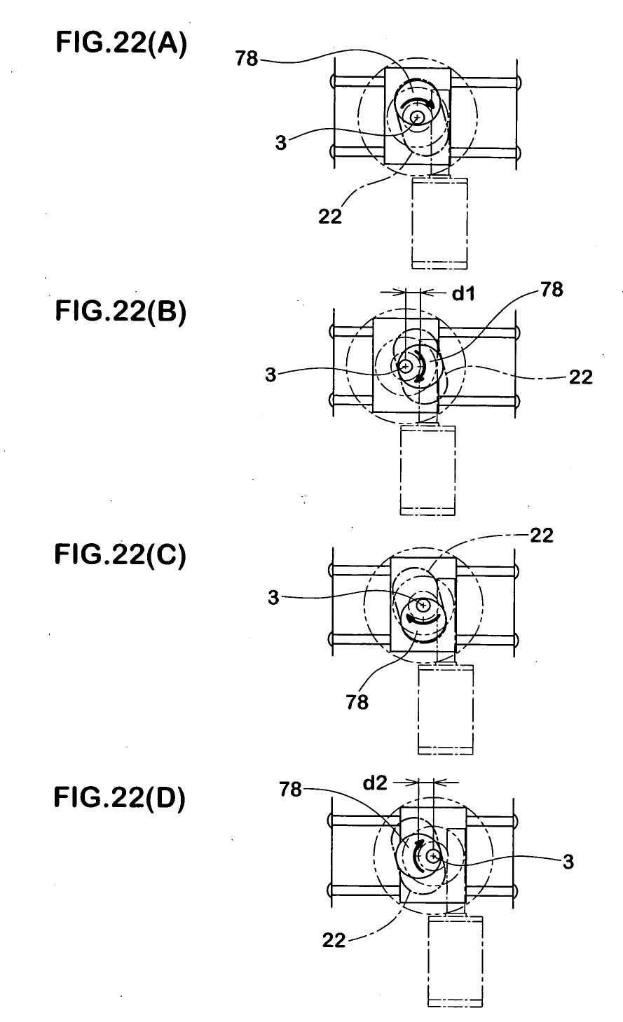

More specifically, as shown in FIG. 22(A), when the circular eccentric cam 78 is in an upper position of the rotation shaft 3, the rotation shaft 3 is disposed in a center position. When the rotation shaft 3 is rotated in the right direction on the drawing, the circular eccentric cam 78 is gradually tilted to the right. At that time, because a right-side surface of the circular eccentric cam 78 slides downward in contact with the inner peripheral surface of the guiding part 22, the rotation shaft 3 relatively moves in the left direction on the drawing. When the rotation shaft 3 is rotated through 90 degrees, as shown in FIG. 22(B), the circular eccentric cam 78 is rotated to the horizontal position on the right-hand side of the rotation shaft 3. As a result, the rotation shaft 3 relatively moves by d1 from the central position to the left. Next, when the rotation shaft 3 is rotated through 180 degrees, as shown in FIG. 22(C), the circular eccentric cam 78 moves to a lower position of the rotation shaft 3. At that time, the rotation shaft 3 returns to the central position. When the rotation shaft 3 is rotated through 270 degrees, as shown FIG. 22(D), the circular eccentric cam 78 is rotated to the horizontal position on the left-hand side of the rotation shaft 3. As a result, the rotation shaft 3 relatively moves by d2 from the central position to the right. When the rotation shaft 3 is rotated through 360 degrees, the circular eccentric cam 78 returns to its original state. As described, it is preferable to use the moving means comprising the tilted guiding part 22 and the circular eccentric cam 78 in sliding contact with the inner peripheral surface of the guiding part because the rotation shaft 3 can be thereby smoothly reciprocated.

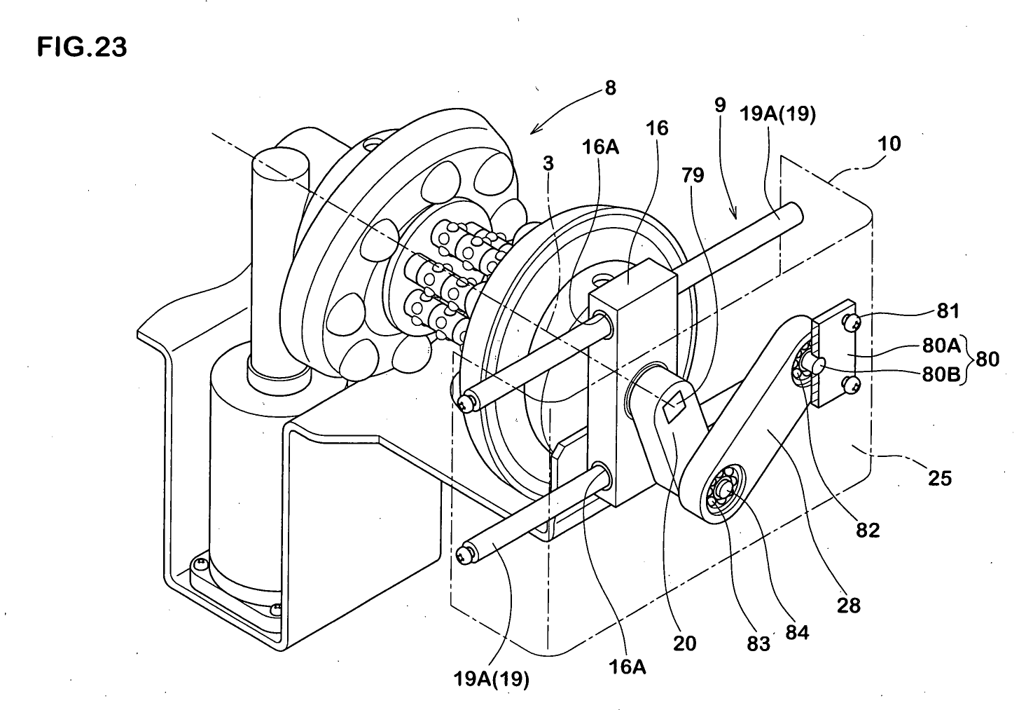

FIG. 23 shows still another embodiment of the present invention. A moving means 9 according to the present embodiment comprises a guiding tool 19, a crank arm 20, and a lever 28. The guiding tool 19, which is constituted in the substantially same manner as in the previous embodiment, comprises a pair of slide shafts 19A having a shape of a horizontal round bar and vertically bridged over the box body 10. The slide shafts 19A are respectively penetrated through the slide holes 16A formed on the bearing tools 16 to thereby slidably support the bearing tools 16, wherein the massage means 8 can be movably supported in the same manner as described in the previous embodiment.

The crank arm 20 has a straight-bar shape, and an end thereof is fixed to an end part of a rotation shaft 3 rotatably supported by the bearing tools 16. The rotation shaft 3 according to the present embodiment is provided with chamfered square shaft parts 79 formed at the end parts thereof protruding from the bearing tools 16. The end of the crank arm 20 is fitted into the square shaft part 79 so that the crank arm 20 is fixed to the rotation shaft 3.

The lever 28 has the straight-bar shape in the same manner as the crank arm 20, and an end thereof is supported by the box body 10. In the present embodiment, the lever 28 is oscillatably supported by means of a receiving tool 80 comprised of a substrate 80A and a receiving shaft 80B provided in the substrate in a protruding manner. More specifically, the end of the lever 28 is engaged with the receiving shaft 80B of the receiving tool 80, the substrate 80A of which is fixed to the leg part 25 of the box body 10, by means of a fitting tool 81 via a bearing 82.

Further, another end of the crank arm 20 and another end of the lever 28 are rotatably engaged with each other by means of a combining pin 84 comprising a bearing 83. In the moving means 9 constituted in the foregoing manner, the lever 28 is oscillated in liaison with the rotation of the crank arm 20, which is rotated in conjunction with the rotation shaft 3. As a result, a linkage device substantially having a slider crank mechanism, wherein the massage means 8 including the bearing tools 16 and the rotation shaft 3 is reciprocated, is formed.

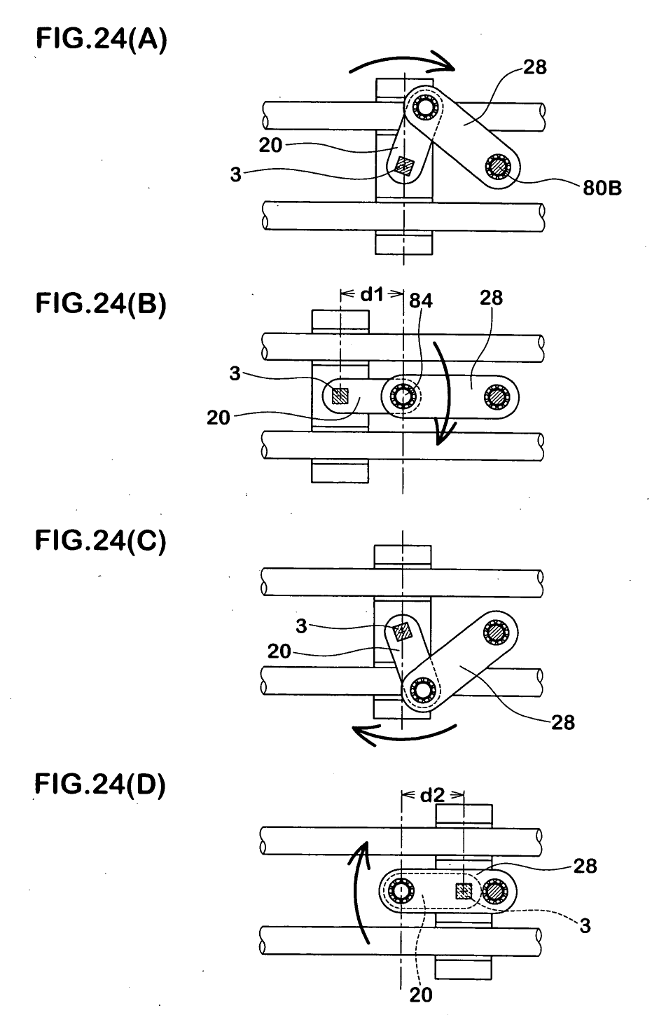

More specifically, as shown in FIG. 24(A), when the crank arm 20 is positioned diagonally upward right relative to the rotation shaft 3 and makes a substantially down-turn shape with the lever 28, the rotation shaft 3 is in a cental position of the reciprocation. When the rotation shaft 3 is rotated in a right direction, the crank arm 20 is rotated in the right direction to be thereby more tilted, while the lever 28 is rotated in a left direction to be thereby more tilted. At that time, an interval between the receiving shaft 80B fixed in the box body 10 and the movable rotation shaft 3 is enlarged, which relatively moves the rotation shaft 3 in the left direction on the drawing. As shown in FIG. 24(B), when the crank arm 20 and the lever 28 are rotated to reach a position where they are extended horizontally in a straight line with the combining pin 84 therebetween, the rotation shaft 3 moves in the left direction by d1 relative to the central position and reaches a left end. Further, as shown in FIG. 24(C), when the crank arm 20 reaches a diagonally downward right position relative to the rotation shaft 3 and makes a substantial V-letter shape with the lever 28, the rotation shaft 3 returns to the central position again. The lever 28 starts to rotate in the right direction in response to a further rotation. As shown in FIG. 24(D), when the crank arm 20 and the lever 28 are rotated to reach a position where they are overlapped with each other, the rotation shaft 3 moves in the right direction by d2 relative to the central position and reaches a right end. When the rotation shaft 3 is rotated through 360 degrees, the initial state shown in FIG. 24(A) is regained.

According to the present embodiment, a linkage length of the crank arm 20 is arranged to be 75 mm, while a linkage length of the lever 28 is arranged to be 110 mm, as a result of which a stroke of the reciprocation is 150 mm. The stroke of the reciprocation, however, can be optionally set in the range of 80-180 mm mentioned earlier by forming the crank arm 20 and the lever 28 in appropriate lengths.

As described, the rotation shaft 3, which is supported by the moving means 9 including the guiding tools 19, crank arms 20, and levers 28, repeatedly reciprocates in the direction orthogonal to its rotational central line. Therefore, the massage bodies 7 provided in the rotation shaft 3 press and stimulate the different massage parts 4 in turn, thereby providing an effective massage effect. Further, the moving means 9 according to the present embodiment constitutes the linkage device substantially having the slider crank mechanism, wherein the crank arm 20 and the lever 28 are rotated in liaison with each other. Because of the constitution, the reciprocation of the massage means 8 can be smooth and noiseless. Besides, the stroke of the reciprocation can be easily enlarged when the linkage lengths of the crank arm 20 and the lever 28 are changed.

1. A massage apparatus comprising:
a massage means provided with massage bodies having pressing parts and provided in a rotation shaft rotated by means of a drive unit, the pressing parts pressing user's massage parts via sheet bodies in conjunction with the rotation of the rotation shaft; and
moving means housed in a box body for reciprocating the massage means in a moving direction orthogonal to a rotational central line of the rotation shaft.

2. A massage apparatus as claimed in claim 1, wherein the massage bodies each comprise a cylindrical body provided in the rotation shaft to be thereby rotated, the cylindrical bodies pressing the massage parts by means of the pressing parts having a protruding shape and formed in outer peripheral surfaces thereof, or pressing boards disposed with intervals therebetween and having the pressing parts in surfaces thereof facing each other, and tiling means for periodically changing distances between the facing pressing parts by repeatedly tilting the pressing boards in reverse directions in conjunction with the rotation of the rotation shaft and thereby sandwiching and massaging the massage parts.

3. A massage apparatus as claimed in claim 1 or claim 2, wherein the pressing parts of the pressing boards have a protruding shape expanded in a direction where the pressing parts face each other.

4. A massage apparatus as claimed in claim 1 or claim 2, wherein the pressing parts of the pressing boards have a smooth and annular surface.

5. A massage apparatus as claimed in, claim 1, wherein the tilting means are tilting receiving pieces supported in a non-rotatable manner relative to the rotation shaft and having tilting bearings tilted to thereby rotatably support the pressing boards.

6. A massage apparatus as claimed in, claim 1, wherein a stroke of the reciprocation is 80 to 180 mm, and the number of reciprocations is 20 to 90 times/min.

7. A massage apparatus as claimed in, claim 1, wherein the massage means comprises the drive unit, the rotation shaft, the massage bodies, and support frames composed of bearing tools disposed on both sides of the rotation shaft, the bearing tools oscillatably supporting the rotation shaft on both ends of the rotation shaft, and a joint member for combining the both-side bearing tools in a non-rotatable manner relative to each other, and
the moving means include guiding tools for supporting the bearing tools and slidably guiding the bearing tools in the moving direction.

8. A massage apparatus as claimed in, claim 1, wherein the moving means each comprise the guiding tool, a crank arm whose one end is fixed to the rotation shaft, and a vertical guide fitting having a vertical guiding part where a guiding body provided on another end of the crank arm can move and fixed to the box body.

9. A massage apparatus as claimed in, claim 1, wherein the moving means each includes the guiding tool, the crank arm whose one end is fixed to the rotation shaft, and a lever whose one end is oscillatably supported by the box body, and another end of the crank arm and another end of the lever are rotatably engaged with each other.

10. A massage apparatus as claimed in, claim 1, wherein the box body includes a pedestal and a leg part provided in a standing manner in the pedestal, the leg part fixing the vertical guide fitting.

11. A massage apparatus as claimed in, claim 1, wherein the drive unit is fixed to the joint member.

12. A massage apparatus as claimed in, claim 1, wherein the drive unit is movably guided in the moving direction by a retaining body provided in the standing manner in the box body, and
the moving means are reciprocating means for reciprocating the bearing tools in the moving direction.
